(19) United States
(12) Patent Application Publication
(10) Pub. No.: US 2026/0170513 A1
(43) Pub. Date: Jun. 18, 2026

(54) CLICK ENGAGEMENT SIGNALS

(71) Applicant: Walmart Apollo, LLC, Bentonville, AR (US)

(72) Inventors: Xinyi Liu, Sunnyvale, CA (US); Manik Goyal, Jersey City, NJ (US); Saisamrit Surbehera, New York, NY (US); Atul Singh, Jersey City, NJ (US); Jingbo Liu, Princeton, NJ (US); Cun Mu, New York, NY (US)

(73) Assignee: Walmart Apollo, LLC, Bentonville, AR (US)

(21) Appl. No.: 18/981,232

(22) Filed: Dec. 13, 2024

(51) Int. Cl. G06Q 30/0201; G06N 20/00

(52) U.S. Cl. CPC G06Q 30/0201; G06N 20/00

(57) ABSTRACT

A computer implemented method including determining an expected click-through-rate (CTR) of a query-item pair with a first machine learning model by using content-based features. The computer implemented method can also include, determining a click engagement (CE) feature by determining a Bayesian inference based on the expected CTR and a historical CTR for the query-item pair. The computer implemented method can further include, determining a rerank score of the query-item pair with a second machine learning model by using the content-based features and the CE feature. The computer-implemented method can additionally include reranking the query-item pair based in part on the rerank score and the expected CTR. Other embodiments are described.

### FIELD OF THE DISCLOSURE

The present disclosure generally relates to determining click engagement (CE) signals with a CTR model.

### BACKGROUND

In online search and recommendation systems, the click-through rate (CTR) is a common metric that measures the effectiveness of displaying items to users. A high CTR indicates that users find the presented items relevant and engaging. However, a significant challenge in these systems is the cold start problem, where new or less-engaged items lack sufficient historical click data, leading to biased and suboptimal ranking. Thus, a solution to address the cold start problem is desired.

### BRIEF DESCRIPTION OF THE DRAWINGS

The figures described below depict various aspects of the systems, methods, and non-transitory computer readable storage media disclosed therein. It should be understood that each figure depicts an embodiment of a particular aspect of the disclosed systems, methods, and non-transitory computer readable storage media, and that each of the figures is intended to accord with a possible embodiment thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a front elevation view of two computer systems and a mobile device that are suitable for implementing an embodiment of the system disclosed in FIG. 4;

FIG. 2 illustrates a representative block diagram of an example of the elements included in the circuit boards inside a chassis of the computer systems of FIG. 1;

FIG. 3 illustrates a block diagram of a search ranking architecture, according to one embodiment;

FIG. 4 illustrates a block diagram of a system for determining click engagement signals through a CTR model, according to one embodiment;

FIG. 5 illustrates a flow chart for a method of determining click engagement signals through a CTR model, according to one embodiment; and

FIG. 6 illustrates four plots of prior and posterior distributions, showing how a tunable shape parameter impacts posterior distributions.

The figures depict embodiments for purposes of illustration only. One skilled in the art will readily recognize from the following discussion that other embodiments of the systems, methods, and non-transitory computer-readable media storing computing instructions that are described herein can be employed without departing from the principles of the technology described herein.

### DETAILED DESCRIPTION

Cold start issues in search ranking systems can result from biases in the historical engagement data. These issues arise from the lack of historical click engagement data for new or less-engaged items. Such inaccuracies present challenges in providing relevant search results, optimizing user experience, and maintaining fair item visibility. For example, a new listing added to an online catalog may never be visible to a user because the new listing added to the online catalog will have no historical click engagement data. This situation may mean that for the new listing's entire cycle, the new listing may receive little to no visibility. Therefore, a system and method to address the impact of cold start issues is desired.

The present embodiments can generally relate to determining click engagement signals through a CTR model, various embodiments can include a computer implemented method including determining an expected click-through-rate (CTR) of a query-item pair (e.g. the likelihood that a user will click on the query-item pair) with a first machine learning model by using content-based features. The computer implemented method can also include determining a click engagement (CE) feature by determining a Bayesian inference based on the expected CTR and a historical CTR for the query-item pair. The computer implemented method can further include determining a rerank score of the query-item pair with a second machine learning model by using the content-based features and the CE feature. The computer-implemented method can additionally include reranking the query-item pair based in part on the rerank score and the expected CTR.

In other embodiments, a system can be provided. The system can include one or more local or remote processors or servers, mobile devices, smart glasses including augmented reality glasses, virtual reality headsets, mixed or extended reality headsets, and/or other electronic or electrical components, which can be in wired or wireless communication with one another. For instance, in one aspect, a computer system can include one or more local or remote processors and/or associated transceivers, along with one or more local or remote non-transitory computer-readable media storing computing instructions that, when run on the one or more processors, direct the one or more processors to perform one or more certain operations. The operations can include determining an expected click-through-rate (CTR) of a query-item pair with a first machine learning model by using content-based features. The operations can also include determining a click engagement (CE) feature by determining a Bayesian inference based on the expected CTR and a historical CTR for the query-item pair. Determining the CE feature can include constructing a prior distribution for the expected CTR comprising a beta distribution. Beta distribution parameters α and β of the prior distribution are derived from the expected CTR and a tunable shape parameter K. Determining the CE feature can also include constructing a posterior distribution on a performance from the prior distribution and a historical CTR for the query-item pair. Determining the CE feature can additionally include determining the CE feature by selecting a point from the posterior distribution for the query-item pair. The operations can further include determining a rerank score of the query-item pair with a second machine learning model by using the content-based features and the CE feature. The operations can additionally include reranking the query-item pair based in part on the rerank score and the expected CTR.

Other embodiments can include a non-transitory computer-readable medium storing computing instructions that, when executed on a processor, cause the processor to perform certain operations. The operations can include determining an expected click-through-rate (CTR) of a query-item pair with a first machine learning model by using content-based features. The operations can also include determining a click engagement (CE) feature by determining a Bayesian inference based on the expected CTR and a historical CTR for the query-item pair. Determining the CE feature can include constructing a prior distribution for the expected CTR comprising a beta distribution. Beta distribution parameters α and β of the prior distribution are derived from the expected CTR and a tunable shape parameter K. Determining the CE feature can also include constructing a posterior distribution on a performance from the prior distribution and a historical CTR for the query-item pair. Determining the CE feature can additionally include determining the CE feature by selecting a point from the posterior distribution for the query-item pair. The operations can further include determining a rerank score of the query-item pair with a second machine learning model by using the content-based features and the CE feature. The operations can additionally include reranking the query-item pair based in part on the rerank score and the expected CTR.

Advantages will become more apparent to those skilled in the art from the following description of the embodiments which have been shown and described by way of illustration. As will be realized, the present embodiments can be capable of other and different embodiments, and their details are capable of modification in various respects. Accordingly, the drawings and description are to be regarded as illustrative in nature and not as restrictive.

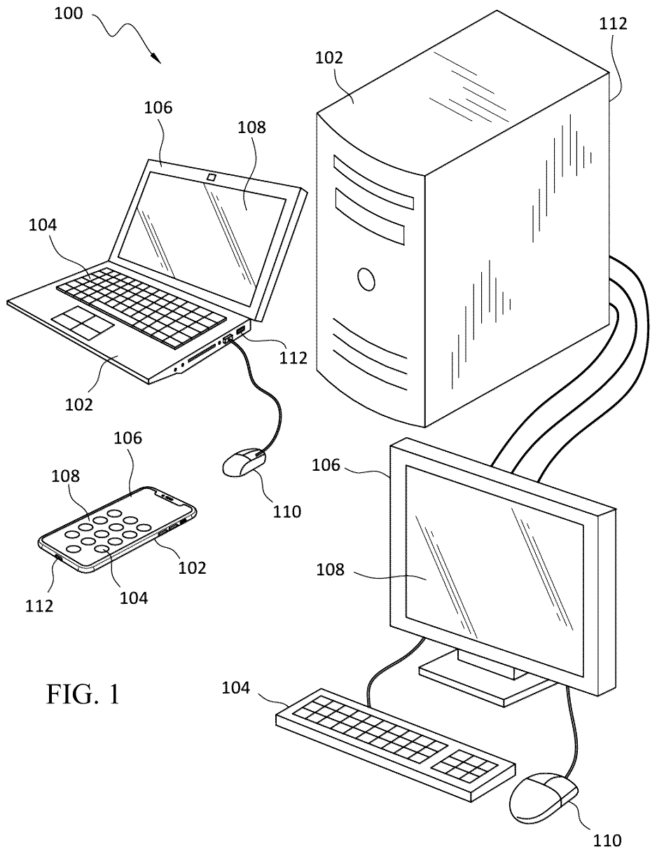

Turning to the drawings, FIG. 1 illustrates an embodiment of three different types (e.g., a laptop, a tower server, and a mobile device) of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part, or all of, the techniques described herein. Computer system 100 can comprise chassis 102 containing one or more circuit boards (not shown) and one or more of an input/output port 112 (e.g., one or more universal serial bus (USB) ports of one or more types (e.g., USB type-A, type-B, type-C, micro-A, micro-B, mini-A, mini-B, etc.), one or more High-Definition Multimedia Interface (HDMI) ports, etc.).

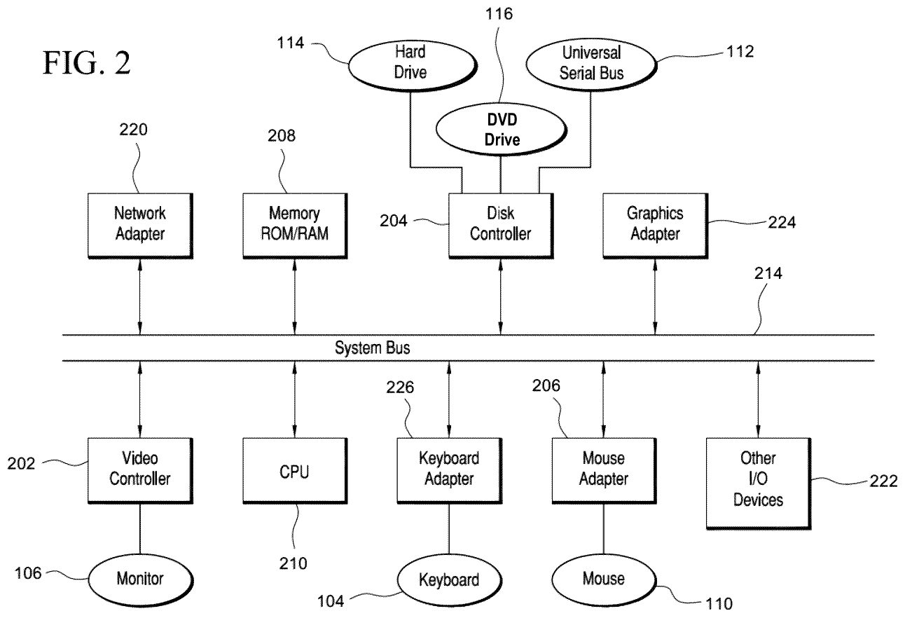

A representative block diagram of the elements included on the circuit boards inside chassis 102 is shown in FIG. 2. A central processing unit (CPU) 210 in FIG. 2 is coupled to a system bus 214. In various embodiments, the architecture of CPU 210 can be compliant with any of a variety of commercially distributed architecture families.

Continuing with FIG. 2, system bus 214 can also be coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to input/output port 112 (FIGS. 1-2)), hard drive 114 (FIG. 2), and/or one or more CD-ROM, DVD, Blu-Ray, or other suitable media, such as media configured to be used in a CD-ROM and/or DVD drive 116 (FIG. 2) inside chassis 102 (FIG. 1) or in a detachable drive coupled to input/output port 112.

Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS by The Open Group Ltd. of Reading, Berkshire in the United Kingdom, and (iv) Linux® OS by Linus Torvalds of Boston, Massachusetts, United State of America.

Further operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O (input/output) devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 can be coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIG. 2), input/output port 112 (FIGS. 1-2), and CD-ROM and/or DVD drive 116 (FIG. 2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 by having wireless communication capabilities integrated into the motherboard chipset (not shown), and/or implemented via one or more dedicated wireless communication chips (not shown), connected through a PCI (peripheral component interconnector) or a PCI express bus of computer system 100 (FIG. 1) or input/output port 112 (FIG. 1). In other embodiments, network adapter 220 can comprise and/or be implemented as a wired network interface controller card (not shown).

Although many other components of computer system 100 are not shown, such components and their interconnection are well-known to those of ordinary skill in the art. Accordingly, further details concerning the construction and composition of computer system 100 and the circuit boards inside chassis 102 are not discussed herein.

When computer system 100 in FIG. 1 is running, program instructions stored on a USB drive in input/output port 112, on a CD-ROM or DVD in CD-ROM and/or DVD drive 116 (FIG. 2) or in the detachable CD-ROM and/or DVD drive coupled to input/output port 112, on hard drive 114 (FIG. 2), or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer.

For purposes of illustration, programs and other executable program components are shown herein as discrete systems, although it is understood that such programs and components can reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a laptop computer, a tower server, or a mobile device in FIG. 1, there can be examples where computer system 100 can take a different form factor while still having functional elements similar to those described for computer system 100. In some embodiments, computer system 100 can comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 can comprise a portable computer, such as a laptop computer. In certain other embodiments, computer system 100 can comprise a mobile device, such as a smartphone, smart glasses, a virtual reality headset, augmented reality glasses, etc. In certain additional embodiments, computer system 100 can comprise an embedded system.

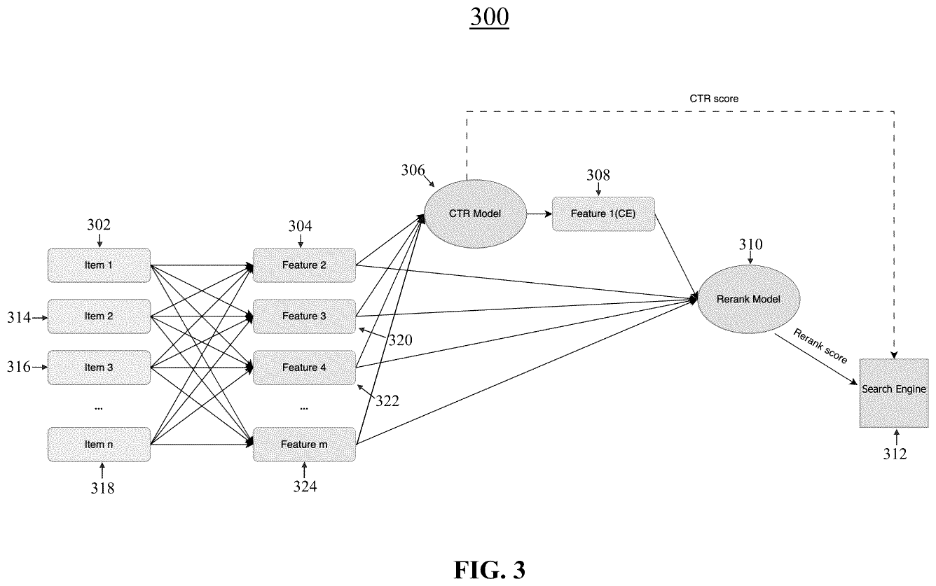

Turning ahead in the drawings, FIG. 3 illustrates an example architecture of the search ranking architecture 300, according to various embodiments. Search ranking architecture 300 is an example, and embodiments of the architecture are not limited to the embodiments presented herein. The search ranking architecture can be employed in many different embodiments or examples not specifically depicted or described herein. In some embodiments, certain elements, modules, or systems of search ranking architecture 300 can perform various procedures, processes, operations, actions, and/or activities. In other embodiments, the procedures, processes, operations, actions, and/or activities can be performed by other suitable elements, modules, or systems of search ranking architecture 300.

In many embodiments, upon receiving a query at run time, search ranking architecture can include obtaining information about items, such as an item 302, an item 314, an item 316, up to an nth item 318, which can be used, for query and item pairs, to obtain query-item features, such as a feature 304, a feature 320, a feature 322, up to an mth feature 324. For example, the features (e.g., features 304, 320, 322, 324) can be relevance and content-based features comprising a content quality score, price signals, a text match, and/or a brand match (which may or may not be in a specific order). As another example, for a query-item pair, the query can be “wireless headphones” and the item can be “ONN.™ BT ON EAR BK”

The features (e.g., 304, 320, 322, 324) can be input into a click-through rate (CTR) model 306. In some embodiments, CTR model 306 can determine an expected CTR of a query-item pair (e.g. likelihood that a user will click on the query-item pair) by using relevance based features (e.g., features 304, 320, 322, 324). CTR model 306 can include a machine learning model and can trained as explained further below. CTR model 306 can further determine a click engagement (CE) feature 308. CE features is a broader metric compared to CTRs. CE features can include historical CTR, dwell time (e.g. time spent on a page after clicking), conversion rates (e.g. percentage of clicks leading toa desired action), bounce rates (e.g. percentage of users leaving quickly after clicking).

CE feature 308, and features 304, 320, 322, 324 can be input into a rerank model 310. Rerank model 310 can determine a rerank score for each query-item pair. Rerank model 310 can include a machine learning model. The rerank score can be received by a search engine 312. Search engine 312 can rank each query-item pair based at least in part on the rerank score and the expected CTR/CTR score.

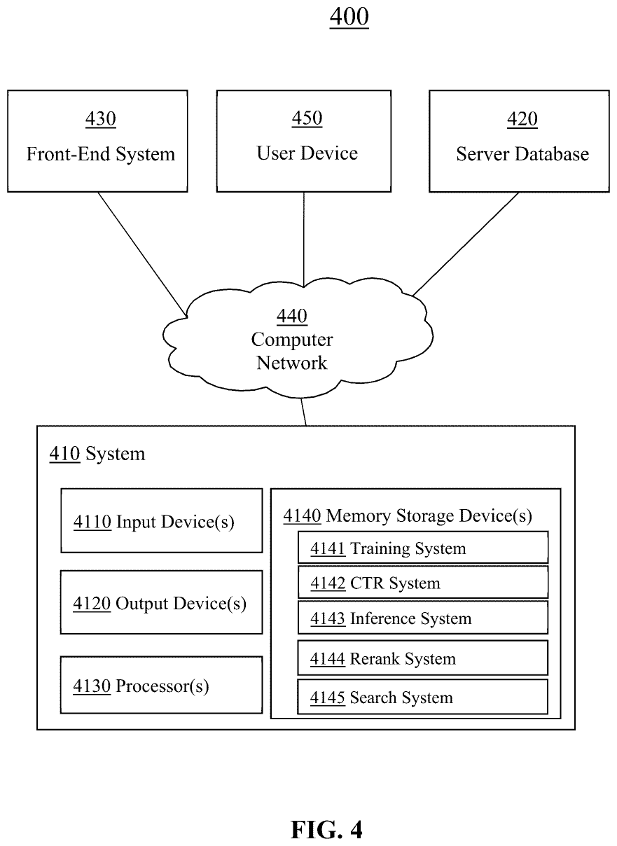

Turning ahead in the drawings, FIG. 4 illustrates a block diagram of a system 400 for determining click engagement signals through a CTR model, according to various embodiments. System 400 can be used to implement search ranking architecture 300 (FIG. 3). System 400 is an example, and embodiments of the system are not limited to the embodiments presented herein. The system can be employed in many different embodiments or examples not specifically depicted or described herein. In some embodiments, certain elements, modules, or systems of system 400 can perform various procedures, processes, operations, actions, and/or activities. In other embodiments, the procedures, processes, operations, actions, and/or activities can be performed by other suitable elements, modules, or systems of system 400.

Generally, system 400 can be implemented with hardware and/or software, as described herein.

In some embodiments, system 400 can include a server database 420 and a system 410. In the same or different embodiments, system 400 also can include a front-end system 430, a computer network 440, and a user device 450.

In some embodiments, of system 410, server database 420, front-end system 430, and/or user device 450 can include systems which may include computing instructions stored on non-transitory computer readable media and executable by one or more processors or may, in addition or as an alternative, include a hardware device comprising electronic circuitry for implementing the functionality described below. For example, system 410 can include memory storage devices 4140 which can include a training system 4141, a CTR system 4142, an inference system 4143, rerank system 4144, and/or a search system 4145, as described further herein below. In other embodiments, system 410, server database 420, front-end system 430, and/or user device 450 can be implemented in hardware, including ASICs (application specific integrated circuits) and the like.

In some embodiments, system 410 can comprise one or more systems, subsystems, modules, models, or servers. Search ranking architecture 300 can be implemented, at least in part, in software and/or firmware stored in or loaded on an internal or remote memory storage device(s) of system 410 and executed on a processor of system 410. In various embodiments, one or more of system 410, front-end system 430, user device 450, and server database 420 can include one or more of trained machine learning (ML) and/or artificial intelligence (AI) models (the ML/AI models) (e.g., CTR model 306 and rerank model 310 (FIG. 3)). System 410, front-end system 430, user device 450, and/or server database 420 can be a component used to implement a portion of the system, method, and/or non-transitory computer-readable medium, as described herein. Additional details regarding system 410, front-end system 430, user device 450, and server database 420 are described herein.

In some embodiments, system 410, server database 420, front-end system 430, and/or user device 450 can be in data communication, through a computer network, a telephone network, or the Internet (e.g., Computer Network 440) with each other. In other embodiments, system 410, server Database 420, front-end system 430, and user device 450 are in direct communication with each other using, for example, Bluetooth communication.

In some embodiments, system 410, server database 420, front-end system 430, and/or user device 450 can include one or more input devices, one or more output devices, one or more processors, and/or one or more memory storage devices. For example, system 410 can include input devices 4110, output devices 4120, processors 4130, and/or memory storage devices 4140. Examples of input devices can include one or more keyboards, one or more keypads, one or more pointing devices such as a computer mouse or computer mice, one or more touchscreen displays, a microphone, a camera, keyboard 104 (FIG. 1), mouse 110 (FIG. 1), etc. Examples of output devices can include one or more monitors, one or more touch screen displays, projectors, monitor 106 (FIG. 1), screen 108 (FIG. 1), etc. Other examples of output devices can include other I/O device 222 (FIG. 2), network adapter 220, wireless transmitters, wired transmitters, and the like. Examples of processors can include CPU 210 (FIG. 2), etc. Examples of memory storage devices can include memory storage unit 208 (FIG. 2), external storage units coupled to input/output port 112 (FIGS. 1-2), hard drive 114 (FIG. 2), CD-ROM and/or DVD drive 116 (FIG. 2), a detachable drive coupled to input/output port 112 (FIGS. 1-2), etc. In a number of embodiments, input devices further can include one or more cameras and/or one or more microphones. In the same or different embodiments, input devices can include one or more GPS (Global Positioning System) sensor(s), one or more accelerometers, and/or one or more gyroscopes.

Input devices and output devices can be coupled to their respective component (e.g., system 410, server database 420, front-end system 430, and/or user device 450) in a wired manner and/or a wireless manner, and the coupling can be direct and/or indirect, as well as locally and/or remotely. As an example of an indirect manner (which can or cannot also be a remote manner), a keyboard-video-mouse (KVM) switch can be used to couple an input device and an output device to a processor and/or a memory storage device, all of a particular user device. In a similar manner, the processors and/or memory storage devices of the user devices can be local and/or remote to each other.

In certain embodiments, user device 450 can be one or more mobile devices, and/or other endpoint devices used by one or more users. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device (e.g., smart glasses, other smart jewelry, augmented-reality (AR) headsets, virtual-reality (VR) headsets, etc.), or another portable computer device with the capability to present audio and/or visual data (e.g., images, videos, music, etc.).

Mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, or (iv) a Galaxy™ Tab or Smartphone or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communications between one or more of system 410, server database 420, front-end system 430, and user device 450 can be implemented using any suitable manner of wired and/or wireless communication. Accordingly, system 410, server database 420, front-end system 430, and user device 450 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). PAN protocol(s) can include Bluetooth, Zigbee, Wireless Universal Serial Bus (USB), Z-Wave, etc.; LAN and/or WAN protocol(s) can include Institute of Electrical and Electronic Engineers (IEEE) 802.3 (also known as Ethernet), IEEE 802.11 (also known as WiFi), etc.; and wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In some embodiments, communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further communication hardware can include wireless communication hardware including, for example, one or more radio transceivers, one or more infrared transceivers, etc. Additional communication hardware can include one or more networking components (e.g., modulator-demodulator components, gateway components, etc.).

In some embodiments, system 410 can be configured to transmit to a user device 450 of a user, or to a graphical user interface (e.g., a webpage, a graphical user interface of a mobile application, etc.) for display on the user device. System 410, server database 420, front-end system 430, and/or user device 450 can determine, by using any suitable approaches or ML/AI models, the statistics, notices, augmented reality views, feedback, and other information. Algorithms for the ML/AI models for determining the information can include decision trees, K Nearest Neighbor (KNN), neural networks, CatBoost, support vector machine, etc.

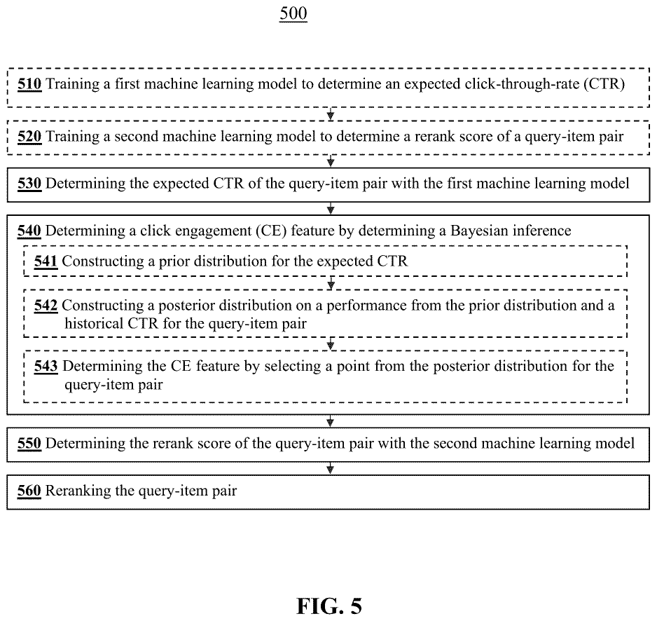

Turning ahead in the drawings, FIG. 5 illustrates a flow chart for a method 500 for determining click engagement signals through a CTR model, according to one embodiment. Method 500 can be implemented via execution of computing instructions configured to run on one or more processors and stored on one or more non-transitory computer-readable media, and/or via one or more ASICs. Method 500 is merely an example and is not limited to the embodiments presented herein. Method 500 can be employed in many different embodiments or examples not specifically depicted or described herein.

In some embodiments, the procedures, the processes, the operations, the actions, and/or the activities of method 500 can be performed in the order presented. In other embodiments, the procedures, the processes, the operations, the actions, and/or the activities of method 500 can be performed in any suitable order. In still other embodiments, one or more of the procedures, the processes, the operations, the actions, and/or the activities of method 500 can be combined together or skipped.

In some embodiments, system 410 (FIG. 4) can be suitable to perform method 500 and/or one or more of the operations, actions, and/or activities of method 500. In these or other embodiments, one or more of the operations, actions, and/or activities of method 500 can be implemented as one or more computing instructions configured to run on one or more processors and configured to be stored on one or more non-transitory computer readable media, and/or as one or more ASICs. Such non-transitory computer readable media can be part of a computer system such as system 410, server database 420, front-end system 430, and/or user device 450. The processor(s) can be similar or identical to the processor(s) described above with respect to computer system 100 (FIG. 1).

Referring to FIG. 5, in some embodiments, method 500 can include a block 510 of training a first machine learning model (e.g. CTR model 306 (FIG. 3)) to determine (e.g., for the purposes of determining) an expected click-through-rate (e.g, the likelihood that a user will click on the query-item pair). For example, the first machine learning model can include a binary classification model and/or another suitable machine learning model. In some embodiments, the model can be a shallow model (e.g. XGBoost) or Gradient Boosted Decision Trees (GBDT). In some embodiments, the first machine learning model's determination of the CTR can be formulated as a binary classification problem with cross-entropy loss as the training objective and with a label being either 0 or 1, wherein:

$${\{ {x}_{i} , {y}_{i} \}}_{i = 1}^{n} , {y}_{i} ∈ [ 0 , 1 ] ; and$$

$$cross entropy loss = {\sum }_{i = 1}^{n} - {y}_{i} log \hat{y} ( {x}_{i} ) - ( 1 - {y}_{i} ) log ( 1 - \hat{y} ( {x}_{i} ) ) .$$

As used herein, n can represent a total number of examples in a dataset; xᵢ can represent the i^{th} example (e.g. i^{th} query item pair); yᵢ can represent an actual value for the i^{th} example; and ŷ(xᵢ) can be a predicted value of label yᵢ for the i^{th} example. As used herein, label yᵢ can be a 0 to indicate that a user did not click on a item of a query item pair, for a query, or a 1 to represent that the user clicked on the item of the query-item pair, for the query. The first machine learning model can be trained using the relevance and quality features of historical query-item pairs (e.g. content quality score, price signals, text match, and brand match).

In some embodiments, the query-item pairs can also use historical CTRs (e.g. CTR using 30 days of aggregated engagement data) as labels in addition to using cross-entropy loss as the training objective, wherein:

$${\{ {x}_{j} , {y}_{j} , {w}_{j} \}}_{j = 1}^{m} , where {w}_{j} = {w}_{j}^{0} + {w}_{j}^{1} ;$$

$${y}_{i} = \frac{{w}_{j}^{1}}{{w}_{j}^{0} + {w}_{j}^{1}} , {y}_{i} ∈ [ 0 , 1 ] ; and$$

$$cross entropy loss = {\sum }_{j = 1}^{m} - {w}_{j}^{1} {y}_{j} log \hat{y} ( {x}_{j} ) - {w}_{j}^{0} ( 1 - {y}_{j} ) log ( 1 - \hat{y} ( {x}_{j} ) ) .$$

Cross entropy loss measures the dissimilarity between the predicted probability distribution (ŷ(xⱼ):) and the true distribution (yⱼ:). The objective function for the training process of the first machine learning model can be cross entropy loss and the goal of the training process can be to minimize this loss.

As used herein, xⱼ can represent the j^{th} query-item pair; yⱼ can represent the label (e.g. historical CTR) for the j^{th} query-item pair; ŷ(xⱼ) can be the predicted value of label yⱼ for the j^{th} query-item pair; wⱼ can be the weight associated with the j^{th} query-item pair; wⱼ can also be the sum of

$${w}_{j}^{0} and {w}_{j}^{1} ;$$

and m can represent the total number of query-item pairs in the dataset.

This approach provides a technical improvement over the conventional formulation because it allows the training data to be condensed to approximately half the size of conventional counterparts, therefore reducing the processing time and computer resources used while achieving similar model performance in term of accuracy.

Continuing with FIG. 5, in some embodiments, method 500 can include a block 520 of training a second machine learning model to determine (e.g., for the purposes of determining) a rerank score of a query-item pair. The rerank score can represent the relevance and likelihood of user engagement for a specific query-item pair based in part on predicted engagement data (e.g. CE feature) and historical engagement data (e.g. historical CTR) and can also include relevance features and quality features (e.g. features 304, 320, 322, 324 (FIG. 3)). For example, the second machine learning model can be trained using relevance features and quality features of historical query-item pairs, along with CE features of the historical query-item pair. In some embodiments, the second machine learning model can include a model (e.g. XGBoost) and/or another suitable machine learning model. The second machine learning model can be trained using an event-level modeling framework. In some embodiment, the second machine learning mode can be rerank model 310 (FIG. 3).

Continuing with FIG. 5, in some embodiments, method 500 can include a block 530 of determining the expected CTR of the query-item pair with the first machine learning model. The expected CTR can be predicted by an online CTR model using relevance features and quality features (e.g., 304, 320, 322, and 324 (FIG. 3)) including content quality score, price signals, text match and brand match. The expected CTR can be predicted by an online CTR model by further using query features such as semanticity. In many embodiments, engagement-based features are not used in the CTR model, so that the CTR model can provide unbiased predictions solely based on content-based features.

Continuing with FIG. 5, in some embodiments, method 500 can include a block 540 of determining a click engagement (CE) feature by determining a Bayesian inference.

Block 540 can include a block 541 of constructing a prior distribution for the expected CTR. Beta distributions can be used to model probability and is the conjugate prior distribution for the binomial distributions in Bayesian inference. The prior distribution for the expected CTR can be a beta distribution constructed with a tunable shaper parameter K, wherein:

$$Beta ( α , β ) = \frac{1}{B ( α , β )} {{x}^{α - 1} ( 1 - x )}^{β - 1} ;$$

$$α = {\hat{p}}_{CTR} K ;$$

$$β = ( 1 - {\hat{p}}_{CTR} ) K ; and$$

$$Expected CTR = {\hat{p}}_{CTR} .$$

Tunable parameter K can be tuned using maximum likelihood estimation (MLE).

Rather than modeling α and β separately, some embodiments can model the ratio of

$$\frac{α}{α + β}$$

and convert to α and β through a parameter K, which is a global parameter that indicates the degree of confidence in prior estimation(s). Parameter K can represent the prior sample size. A small K indicates that the posterior distribution is more influenced by evidence, which is historical click engagement. A large K indicates that the posterior distribution is more influenced by the prior belief. Parameter K can be tuned using maximum likelihood estimation (MLE).

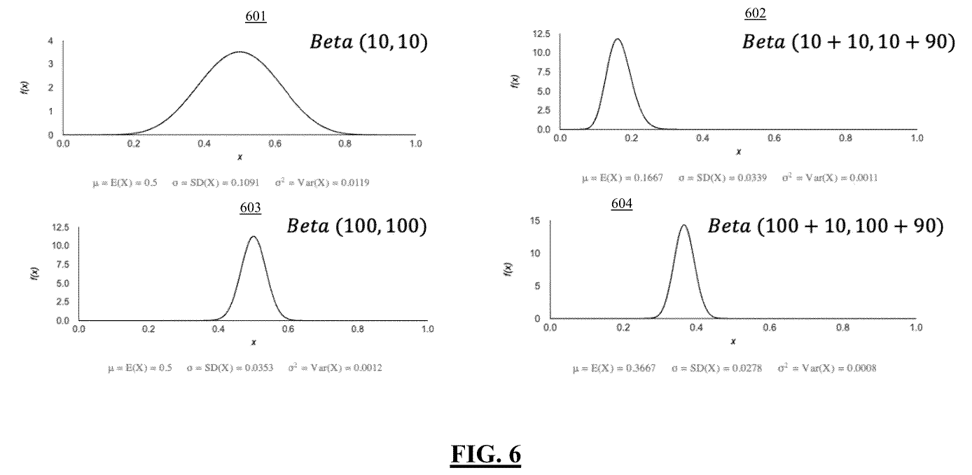

FIG. 6 illustrates four plots of prior distributions and posterior distributions, showing of how tunable parameter K values impact the posterior distribution. For these plots, \hat{p}=0.5; observed data 100 is with impressions 10 clicks; Prior˜Beta (\hat{p}k, k−\hat{p}k); Posterior˜Beta (\hat{p}k+clicks, k−\hat{p}k+impressions−clicks). In plot 601 and 602, k=20, and posterior mean=0.167. Plot 601 shows the prior distribution for Beta(10,10), while plot 602 shows the posterior distribution for Beta(10+10,10+90). In plot 603 and 604, k=200, and posterior mean=0.367. Plot 603 shows the prior distribution for Beta(100,100), while plot 604 shows the posterior distribution for Beta(100+10,100+90).

Returning to FIG. 5, block 540 can also include a block 542 of constructing a posterior distribution on a performance from the prior distribution and a historical CTR for the query-item pair. The posterior distribution can be constructed with the expected CTR as a prior belief and historical clicks information observed from data. The posterior distribution represents how each query-item pair would perform, wherein:

$$Prior belief \text{:} θ \sim Beta ( {α}_{0} , {β}_{0} ) ;$$

$$\hat{p} = {f}_{CTR} ( x ) ;$$

$${α}_{0} = \hat{p} k , {β}_{0} = k - \hat{p} k ;$$

$$Evidence \text{:} {X}_{1} , {X}_{2} , … , {X}_{n} {\sim}^{i . i . d} Ber ( θ ) ;$$

$$Posterior \text{:} θ \vert {X}_{1} = {x}_{1} , … , {X}_{n} = {x}_{n} \sim Beta ( {α}_{0} + \sum {x}_{i} , {β}_{0} + n - \sum {x}_{i} ) ;$$

$$\sim Beta ( \hat{p} k + m , k - \hat{p} k + n - m ) , \sum {x}_{i} = m .$$

As used herein, θ can represent the unknown parameter being determined. In some embodiments, θ represents a true CTR. As used herein, α₀ and β₀ are the parameters of the prior Beta distribution. In some embodiments, they can characterize the prior belief of θ without observing any data (e.g, the historical CTR). As used herein, \hat{p} is the initial estimate of the CTR, which can be used to set the parameters of the prior Beta distribution. As used herein, k is the constant that can determine the strength of the prior belief. For example, a larger k value corresponds to a stronger prior belief. X₁, X₂, . . . , Xₙ can be independent and identically distributed (i.i.d.) random variables representing the outcomes of n trials. In some embodiments, each Xᵢ is a Bernoulli-distributed variable representing whether a user clicks (1) or doesn't click (0) on a given item. As used herein, m can be the total number of clicks observed in n trials (i.e. the sum of the Xᵢ's). As used herein, n can be the total number of trials or the total number of items examiner by the users.

In some implementations, block 540 can further include a block 543 of determining the CE feature by selecting a point from the posterior distribution for the query-item pair. Determining the CE feature can comprise selecting the posterior mean. Determining the CE feature can also comprise selecting a sample (e.g. Thompson sample), a quantile of the posterior distribution or an approximated upper confidence bound. For example:

$$Quantile \text{:} {f}_{CE , quantile} = {Q}_{0.05} ( {Dist}_{posterior} )$$

$$Posterior mean \text{:} {f}_{CE , mean} = mean ( {Dist}_{posterior} ) = \frac{{α}_{0} + m}{{α}_{0} + {β}_{0} + n}$$

$$Sampled \text{:} {f}_{CE , sampled} \sim Sampled ( {Dist}_{posterior} )$$

$$Approximated Upper Confidence Bound \text{:} \frac{{α}_{0} + m}{{α}_{0} + {β}_{0} + n} + \sqrt{\frac{log ( \frac{1}{δ} )}{2 ( {α}_{0} + {β}_{0} + n + 1 )}}$$

Continuing with FIG. 5, in some embodiments, method 500 can include a block 550 of determining the rerank score of the query-item pair with the second machine learning model. In one embodiment, rerank model 310 (FIG. 3) can determine the rerank score of each query-item pair with the CE feature determined for the query-item pair in block 540 (FIG. 5) together with the content-based features (e.g., 304, 320, 322, and 324 (FIG. 3)) for each query-item pair to determine a rerank score of the query-item pair for search engine 312 (FIG. 3).

Continuing with FIG. 5, in some embodiments, method 500 can include a block 550 of reranking the query-item pair. In some embodiments, search engine 312 (FIG. 3) can rerank each query-item pair of the query-item pairs. For example, the query-item pairs can be ranked in descending order of the rerank score. By virtue of reranking the query-item pairs (with the rerank score), new or less-engaged query-item pairs can be ranked higher compared to conventional methods of ranking where the same query-item pairs are ranked lowly due to lack of historical click data.

For each of the machine learning models to be retrained, the respective training datasets can be updated manually by a system user (e.g., an ML engineer, a data scientist, etc.) and/or automatically by a system (e.g., system 410 (FIG. 4)). The system user can select new training data from various data sources. The system can collect new training data based upon various criteria. In certain embodiments, historical input and/or output data of the model to be re-trained can be used for re-training the model. In several embodiments, the historical input and/or output data of the model can be selected based upon system performance and/or user feedback from the system user associated with the historical output data. In various embodiments, when more than one training dataset is used for the pretraining and/or retraining, the system (e.g., system 410 (FIG. 4)) can format or re-format the data of the more than one training dataset (especially when datasets are from different sources) so that the hierarchy, schema, and/or other aspects of the data of the more than one training dataset follow a common hierarchy, structure, schema, etc., and so that the data of the more than one training dataset can be more easily used to pretrain or retrain the one or more machine learning models. The system can predetermine the common hierarchy, structure, schema, etc. As needed, the system can reformat the data from various training dataset into a common data format so that the data can be used properly and efficiently by the system.

In some embodiments, the machine learning models, AI algorithms, classifiers, etc. can be customized and/or fine-tuned for the user. For example, the customized classifiers can be stored locally on system 410 (FIG. 4). As another example, one or more of these customized classifiers can be trained and/or retrained remotely and stored locally (e.g., at system 410 (FIG. 4)).

Examples of the algorithms used for the various ML/AI models for one or more of the above-mentioned procedures, processes, activities, actions, operations, and/or methods can include BERT (Bidirectional Encoder Representations from Transformers), LLM (Language Learning Models), Lambda, Palm, XLNet, GPT-3 (generative pretraining transformer), GPT-4, KNN (k-nearest neighbor), decision trees, linear regression, logistic regression, K-Means, neural networks, fuzzy logic, GANs (generative adversarial networks), CTGAN (cloud transformer generative adversarial networks), CNNs (convolutional neural networks), VAEs (variational autoencoder), and so forth. In various embodiments, each of the ML/AI models used can be trained and/or retrained dynamically and/or regularly.

In some embodiments, the systems and/or methods can be configured to train or re-train the one or more ML/AI models. The training of each of the ML/AI models can be supervised, semi-supervised, and/or unsupervised—which in some embodiments can be followed by, or used in conjunction with, other techniques, such as re-enforcement machine learning techniques, or other techniques utilized by ChatGPT-based voice bots or virtual assistants. The training data of training datasets for pretraining or retraining each of the ML/AI models can be collected from various data sources, including historical input and/or output data by the ML/AI model. The collection and update of the training data in the training datasets can be performed once, periodically (e.g., every day, every week, etc.), or constantly. For example, in certain embodiments, the input and/or output data of an ML/AI model can be curated by a user (e.g., an ML engineer, a data scientist, etc.) or automatically collected every time the ML/AI model generates new output data to update the training datasets for re-training the ML/AI model. In some embodiments, the trained and/or re-trained ML/AI model as well as the training datasets can be stored in, updated, and accessed from a database. In the same or different embodiments, when more than one training dataset is used for the pretraining and/or re-training, the data of the more than one training dataset can be formatted or reformatted so that the hierarchy, schema, and/or other aspects of the data of the more than one training dataset (especially when datasets are from different sources) follow a common hierarchy, structure, schema, etc., and so that the data of the more than one training dataset can be more easily used to pretrain or retrain the one or more machine learning models. In some embodiments, the common hierarchy, structure, schema, etc. can be predetermined.

In some embodiments, the users, systems, and/or methods further can determine whether to add the newly created historical input and/or output data to the training dataset for retraining the ML/AI models based upon user feedback and/or predetermined criteria. The user feedback can be associated with the output data of the ML/AI models or the output of the systems and/or methods using the ML/AI models.

Relating FIG. 5 to FIG. 4, as an example, training system 4141 (FIG. 4) can perform block 510 and block 520; CTR system 4142 (FIG. 4) can perform block 530; inference system 4143 (FIG. 4) can perform block 540, including 541-543; rerank system 4144 (FIG. 4) can perform block 550 and block 560; and/or search system 4145 (FIG. 4) can perform searches/queries.

In certain embodiments where machine learning techniques are not explicitly described in the processes, procedures, activities, operations, actions, and/or methods, such processes, procedures, activities, operations, actions, and/or methods can be read to include machine learning techniques suitable to perform the intended activities (e.g., determining, processing, analyzing, predicting, etc.). In several embodiments, the one or more ML/AI models can be configured to start or stop automatically upon occurrence of predefined events and/or conditions. In certain embodiments, the systems and/or methods can use a pretrained ML/AI model, without any re-training.

Although systems and methods for determining click engagement signals through a CTR model have been described with reference to specific embodiments, it will be understood by those skilled in the art that various changes can be made without departing from the spirit or scope of the disclosure. Accordingly, the disclosure of embodiments is intended to be illustrative of the scope of the disclosure and is not intended to be limiting.

It is intended that the scope of the disclosure shall be limited only to the extent required by the appended claims. For example, to one of ordinary skill in the art, it will be readily apparent that any element of FIGS. 1-5 can be modified, and that the foregoing discussion of certain of these embodiments does not necessarily represent a complete description of all possible embodiments. Additionally, one or more of the procedures, processes, operations, actions, and/or activities of the method in FIG. 5 can include different procedures, processes, actions, and/or activities and be performed by many different modules, in many different orders. As an example, the modules, models, elements, and/or systems within system 400 in FIG. 4 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that can cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

As will be appreciated based upon the foregoing specification, the above-described embodiments of the disclosure can be implemented using computer programming or engineering techniques including computer software, firmware, hardware or any combination or subset thereof. Any such resulting program, having computer-readable code means, can be embodied, or provided within one or more computer-readable media, thereby making a computer program product, e.g., an article of manufacture, according to the discussed embodiments of the disclosure. The computer-readable media can be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code can be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” may be interchangeable and include any computer program stored in memory for execution by a processor, including RAM memory, ROM memory, EPROM (erasable programmable read-only memory) memory, EEPROM (electrically erasable programmable read-only memory) memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an embodiment, the system can be executed on a single computer system, without requiring a connection to a server computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various environments without compromising any major functionality. In some embodiments, the system includes multiple components distributed among a plurality of computing devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements, actions, operations, or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

For simplicity and clarity of illustration, the drawing figures illustrate the general manner of construction, and descriptions and details of well-known features and techniques can be omitted to avoid unnecessarily obscuring the present disclosure. Additionally, elements in the drawing figures are not necessarily drawn to scale. For example, the dimensions of some of the elements in the figures can be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but can include other elements not expressly listed or inherent to such process, method, system, article, device, or apparatus.

The terms “couple,” “coupled,” “couples,” “coupling,” and the like should be broadly understood and refer to connecting two or more elements mechanically and/or otherwise. Two or more electrical elements can be electrically coupled together, but not be mechanically or otherwise coupled together. Coupling can be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “approximately” may, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

This written description uses examples to disclose the disclosure and to enable any person skilled in the art to practice the disclosure, including making and using any devices or computer systems and performing any incorporated computer-based or computer-implemented methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method comprising:
determining an expected click-through-rate (CTR) of a query-item pair with a first machine learning model by using content-based features;
determining a click engagement (CE) feature by determining a Bayesian inference based on the expected CTR and a historical CTR for the query-item pair;
determining a rerank score of the query-item pair with a second machine learning model by using the content-based features and the CE feature; and
reranking the query-item pair based in part on the rerank score and the expected CTR.

2. The computer-implemented method of claim 1 further comprising:
training the first machine learning model to determine the expected CTR with training data, wherein:
a training objective for training the first machine learning model is reducing a cross-entropy loss; and
the training data comprises query-item pairs and respective historical CTRs.

3. The computer-implemented method of claim 1 further comprising training the second machine learning model to determine the rerank score of the query-item pair.

4. The computer-implemented method of claim 1, wherein determining the Bayesian inference comprises:
constructing a prior distribution for the expected CTR comprising a beta distribution, wherein beta distribution parameters α and β of the prior distribution are derived from the expected CTR and a tunable shape parameter K;
constructing a posterior distribution on a performance from the prior distribution and the historical CTR for the query-item pair; and
determining the CE feature by selecting a point from the posterior distribution for the query-item pair.

5. The computer-implemented method of claim 4, wherein:
the beta distribution models a ratio of
$$\frac{α}{α + β} ;$$
and
α and β are derived from the tunable shape parameter K.

6. The computer-implemented method of claim 5, wherein:
the prior distribution comprises a beta distribution
$$Beta ( α , β ) = \frac{1}{B ( α , β )} {{x}^{α - 1} ( 1 - x )}^{β - 1} ,$$
wherein:
$$α = {\hat{p}}_{CTR} K ;$$
$$β = ( 1 - {\hat{p}}_{CTR} ) K ; and$$
$${\hat{p}}_{CTR} is the expected CTR .$$

7. The computer-implemented method of claim 4, wherein determining the point from the posterior distribution comprises determining at least one of:
a mean of the posterior distribution;
a Thompson sample of the posterior distribution; or
a quantile rate of the posterior distribution.

8. The computer-implemented method of claim 4, wherein the tunable shape parameter K is tuned using maximum likelihood estimation.

9. The computer-implemented method of claim 1, wherein the content-based features comprise:
a content quality score;
price signals;
a text match; and
a brand match.

10. The computer-implemented method of claim 1, wherein the expected CTR of the query-item pair is determined with the first machine learning model without using engagement-based features.

11. A system comprising:
a processor; and
a non-transitory computer-readable medium storing computing instructions that, when run on the processor to cause the processor to perform operations comprising:
determining an expected click-through-rate (CTR) of a query-item pair with a first machine learning model by using content-based features;
determining a click engagement (CE) feature, comprising:
constructing a prior distribution for the expected CTR comprising a beta distribution, wherein beta distribution parameters α and β of the prior distribution are derived from the expected CTR and a tunable shape parameter K;
constructing a posterior distribution on a performance from the prior distribution and a historical CTR for the query-item pair; and
determining the CE feature by selecting a point from the posterior distribution for the query-item pair;
determining a rerank score of the query-item pair with a second machine learning model by using the content-based features and the CE feature; and
reranking the query-item pair based in part on the rerank score and the expected CTR.

12. The system of claim 11, wherein the operations further comprise:
training the first machine learning model to determine the expected CTR with training data, wherein:
a training objective for training the first machine learning model is reducing a cross-entropy loss; and
the training data comprises query-item pairs and respective historical CTRs.

13. The system of claim 11, where the operations further comprise training the second machine learning model to determine the rerank score of the query-item pair.

14. The system of claim 11, wherein:
the beta distribution models a ratio of
$$\frac{α}{α + β} ;$$
and
α and β are derived from the tunable shape parameter K.

15. The system of claim 14, wherein:
the prior distribution comprises a beta distribution
$$Beta ( α , β ) = \frac{1}{B ( α , β )} {{x}^{α - 1} ( 1 - x )}^{β - 1} ,$$
wherein:
$$α = {\hat{p}}_{CTR} K ;$$
$$β = ( 1 - {\hat{p}}_{CTR} ) K ; and$$
$${\hat{p}}_{CTR} is the expected CTR .$$

16. The system of claim 11, wherein determining the point from the posterior distribution comprises determining at least one of:
a mean of the posterior distribution;
a Thompson sample of the posterior distribution; or
a quantile rate of the posterior distribution.

17. The system of claim 11, wherein the tunable shape parameter K is tuned using maximum likelihood estimation.

18. The system of claim 11, wherein the content-based features comprise:
a content quality score;
price signals;
a text match; and
a brand match.

19. A non-transitory computer readable storage medium storing computing instructions that, when run on a processor, cause the processor to perform operations comprising:
determining an expected click-through-rate (CTR) of a query-item pair with a first machine learning model by using content-based features;
determining a click engagement (CE) feature with the first machine learning model comprising:
constructing a prior distribution for the expected CTR comprising a beta distribution, wherein beta distribution parameters α and β of the prior distribution are derived from the expected CTR and a tunable shape parameter K, wherein the tunable shape parameter K is tuned using maximum likelihood estimation;
constructing a posterior distribution on a performance from the prior distribution and a historical CTR for the query-item pair; and
determining the CE feature by selecting a point from the posterior distribution for the query-item pair;
determining a rerank score of the query-item pair with a second machine learning model by using the content-based features and the CE feature; and
reranking the query-item pair based in part on the rerank score and the expected CTR.

20. The non-transitory computer readable storage medium of claim 19, wherein the operations further comprise:
training the first machine learning model to determine the expected CTR with training data, wherein:
a training objective for training the first machine learning model is reducing a cross-entropy loss; and
the training data comprises query-item pairs and respective historical CTRs.
